(19) United States
(12) Patent Application Publication
(10) Pub. No.: US 2024/0052823 A1
(43) Pub. Date: Feb. 15, 2024

(54) ACTUATOR AND FLUID CONTROL APPARATUS

(71) Applicant: Murata Manufacturing Co., Ltd., Kyoto (JP)

(72) Inventor: Yutoku KAWABATA, Kyoto (JP)

(21) Appl. No.: 18/493,958

(22) Filed: Oct. 25, 2023

Related U.S. Application Data
(63) Continuation of application No. PCT/JP2022/017807, filed on Apr. 14, 2022.

(30) Foreign Application Priority Data
Apr. 27, 2021 (JP) 2021-074739

(51) Int. Cl. F04B 43/04

(52) U.S. Cl. CPC F04B 43/046

(57) ABSTRACT

An actuator includes a main plate, a frame, a connection member, and a piezoelectric element. The main plate has a principal surface and a principal surface and has a rotationally symmetrical shape as viewed in plan. The frame is disposed at a position outside a peripheral edge of the main plate. The connection member is connected to the peripheral edge of the main plate and to the frame. The connection member holds the main plate so as to enable the main plate to vibrate relative to the frame. The piezoelectric element is disposed on the principal surface of the main plate, and the circumferential shape of the piezoelectric element is smaller than the main plate. The main plate includes a recess and a thin portion in a region that includes a center and a peripheral edge of the main plate and that overlaps the piezoelectric element as viewed in plan.

### CROSS REFERENCE TO RELATED APPLICATION

This is a continuation of International Application No. PCT/JP2022/017807 filed on Apr. 14, 2022 which claims priority from Japanese Patent Application No. 2021-074739 filed on Apr. 27, 2021. The contents of these applications are incorporated herein by reference in their entireties.

### BACKGROUND OF THE DISCLOSURE

### Field of the Disclosure

The present disclosure relates to an actuator having a structure in which a driving device, such as a piezoelectric element 30, vibrates a flat plate.

### Description of the Related Art

Patent Document 1 discloses a piezoelectric pump equipped with an actuator. The actuator of Patent Document 1 is formed by attaching a piezoelectric element to a diaphragm shaped like a circular disk.

An outer frame is disposed outside the diaphragm. A beam-like connection member connects the diaphragm to the outer frame. The diaphragm is thereby supported so as to be able to vibrate relative to the outer frame.

When the actuator is viewed in plan, in other words, when the actuator is viewed in the direction normal to the principal surface of the diaphragm while the amplitude of vibration of the diaphragm is zero, the center of the piezoelectric element coincides with the center of the diaphragm.

The piezoelectric element is made of a piezoelectric body and driving electrodes disposed on the principal surfaces of the piezoelectric body.

Patent Document 1: Japanese Patent No. 5177331

### BRIEF SUMMARY OF THE DISCLOSURE

The piezoelectric body is made of a brittle material, and cracks CR tend to occur when the tensile stress exceeds the compressive stress. When cracks are generated and connected to each other, a region surrounded by the cracks CR becomes isolated from the other part of the piezoelectric element.

The driving voltage is not applied to the isolated region, which causes the strain to decrease in this region of the piezoelectric element. As a result, the amplitude of vibration of the actuator diminishes, leading to a deterioration in the characteristics of the actuator.

Accordingly, a possible benefit of the present disclosure is to provide an actuator that can suppress a reduction in the amplitude of vibration even if cracks occur in the piezoelectric element.

According to the present disclosure, an actuator includes a main plate, a frame, a connection member, and a piezoelectric element. The main plate has a first principal surface and a second principal surface and has a rotationally symmetrical shape as viewed in plan in a direction normal to the first principal surface and the second principal surface. The frame is disposed at a position outside a peripheral edge of the main plate. The connection member is connected to the peripheral edge of the main plate and to the frame. The connection member holds the main plate so as to enable the main plate to vibrate relative to the frame. The piezoelectric element is disposed on the first principal surface of the main plate, and the circumferential shape of the piezoelectric element is smaller than the main plate. The main plate includes a low elastic modulus region that, as viewed in plan, overlaps the piezoelectric element and that does not include the peripheral edge nor a rotation center of the main plate. The low elastic modulus region has an elastic modulus smaller than that of a central region of the main plate positioned in the vicinity of the rotation center.

With this configuration, the amplitude of vibration of the main plate becomes large in a deformation control region, resulting in an increase in tensile stress. Since the deformation control region is disposed at a position away from the center of the main plate and of the piezoelectric element, the isolated region surrounded by cracks does not occur easily even if cracks occur. This reduces the likelihood that a region where the driving voltage is not applied occurs in the piezoelectric element,

According to the present disclosure, a reduction in the amplitude of vibration can be suppressed in the actuator even if cracks occur in the piezoelectric element.

### BRIEF DESCRIPTION OF THE SEVERAL VIEWS OF THE DRAWINGS

FIG. 1 is an exploded perspective view illustrating a fluid control apparatus including an actuator in accordance with a first embodiment.

FIG. 2A is a plan view illustrating the actuator according to the first embodiment, and FIG. 2B is a cross-sectional view thereof taken along line A-A in FIG. 2A.

FIG. 3 is a graph illustrating a distribution example of tensile stress.

FIG. 4A is a view illustrating an example of the generation of cracks CR in the actuator according to the first embodiment, and FIG. 4B is a view illustrating an example of the generation of cracks CR in a known actuator.

FIG. 5 is a graph illustrating a relationship between the position of a thin portion 219 and normalized service life.

FIG. 6A is a plan view illustrating an actuator according to a second embodiment, and FIG. 6B is a cross-sectional view thereof taken along line B-B in FIG. 6A.

FIG. 7 is a plan view illustrating an actuator according to a third embodiment.

FIG. 8A is a plan view illustrating an actuator according to a fourth embodiment, and FIG. 8B is a cross-sectional view thereof taken along line C-C in FIG. 8A.

FIG. 9A is a plan view illustrating an actuator according to a fifth embodiment, and FIG. 9B is a cross-sectional view thereof taken along line D-D in FIG. 9A.

FIG. 10A is a plan view illustrating an actuator according to a sixth embodiment, and FIG. 10B is a cross-sectional view thereof taken along line E-E in FIG. 10A.

FIG. 11 is a cross-sectional side view illustrating an actuator according to a seventh embodiment.

FIG. 12A is a plan view illustrating an actuator according to an eighth embodiment, and FIG. 12B is a cross-sectional view thereof taken along line F-F in FIG. 12A.

FIG. 13 is a cross-sectional side view illustrating an actuator according to a ninth embodiment.

### DETAILED DESCRIPTION OF THE DISCLOSURE

### First Embodiment

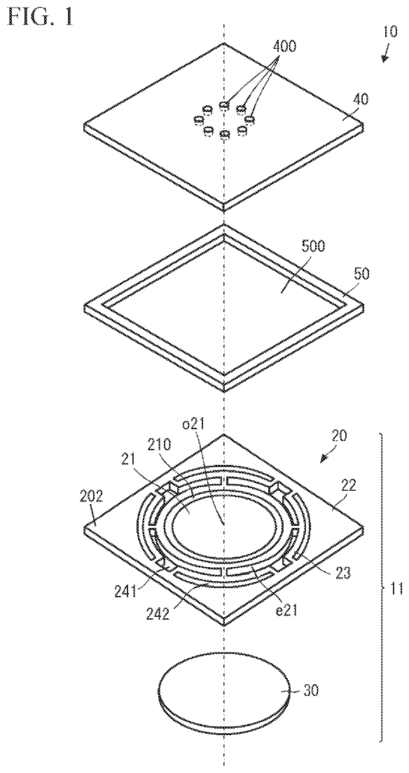

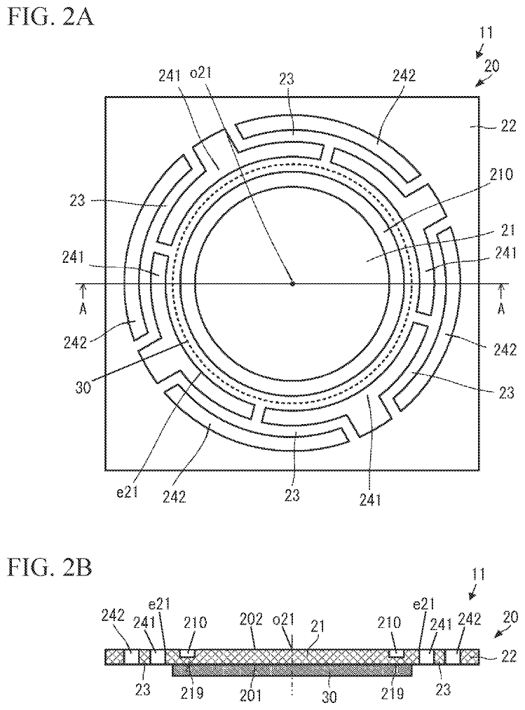

An actuator and a fluid control apparatus according to a first embodiment of the present disclosure will be described with reference to the drawings. FIG. 1 is an exploded perspective view illustrating the fluid control apparatus including the actuator in accordance with the first embodiment. FIG. 2A is a plan view illustrating the actuator of the first embodiment, and FIG. 2B is a cross-sectional view thereof taken along line A-A in FIG. 2A. In the drawings, the structural elements of the actuator as well as of the fluid control apparatus may be illustrated in an exaggerated manner partially or entirely in order to facilitate better understanding of the structure of the actuator and the fluid control apparatus in the following description of the embodiments including the present one.

### (Structure of Actuator 11)

As illustrated in FIGS. 1, 2A, and 2B, an actuator 11 includes a flat plate member 20 and a piezoelectric element 30.

### (Structure of Flat Plate Member 20)

The flat plate member 20 is made, for example, of a metallic plate and has a principal surface 201 and a principal surface 202. The flat plate member 20 includes a main plate 21, a frame 22, and multiple connection members 23. For example, the main plate 21, the frame 22, and the connection members 23 are formed integrally from a single flat plate.

The main plate 21 is a flat plate having a principal surface 201 and a principal surface 202. The principal surface 201 corresponds to a “first principal surface” of the present disclosure, and the principal surface 202 corresponds to a “second principal surface” of the present disclosure.

The main plate 21 is shaped like a circular disk as viewed in plan (in other words, the main plate 21 is viewed in the direction normal to the principal surface 201 and the principal surface 202 or in the thickness direction thereof). The main plate 21 has a center o21 and a peripheral edge e21. Note that the shape of the main plate 21 is not limited to a circular disk but may be another rotationally symmetrical shape with respect to the center o21 as a reference point. In such a case, the present disclosure can be applied and the effects described herein can be obtained.

The main plate 21 includes a thin portion 219 formed therein. The shape and the position of the thin portion 219 will be described specifically later.

The frame 22 is a flat plate, and the circumferential shape thereof is like a square when the frame 22 is viewed in plan. The circumferential shape of the frame 22 is not limited to the square. The frame 22 has an opening. The opening is formed through the flat plate of the frame 22 in the thickness direction thereof. The opening is shaped like a circle as viewed in plan. The shape of the opening is similar to, but larger than, the peripheral edge e21 of the main plate 21.

The main plate 21 is disposed inside the opening of the frame 22. Here, the center o21 of the main plate 21 coincides with the center of the opening. The peripheral edge e21 of the main plate 21 is smaller in shape than the opening of the frame 22. Accordingly, when the main plate 21 is disposed inside the opening of the frame 22, the peripheral edge e21 of the main plate 21 is spaced from the frame 22.

The connection members 23 are shaped like beams. The connection members 23 are disposed in the opening or a space between the main plate 21 and the frame 22. The connection members 23 are disposed along the peripheral edge e21 of the main plate 21 so as to have a space between adjacent connection members 23.

Each connection member 23 includes an inner connector, a beam, and outer connectors. The beam is elongated along the peripheral edge e21 of the main plate 21. The inner connector connects the peripheral edge e21 of the main plate 21 to a substantially central portion of the beam, the central portion being positioned in the elongated direction thereof. The outer connectors connect the frame 22 to the ends of the beam, the ends being positioned opposite to each other in the elongated direction thereof.

Accordingly, the main plate 21 is supported by multiple connection members 23 so as to enable the main plate 21 to vibrate in the bending vibration mode with respect to the frame 22.

The piezoelectric element 30 is shaped like a circular disk as viewed in plan. The circumferential shape of the piezoelectric element 30 is smaller than the circumferential shape (i.e., the peripheral edge e21) of the main plate 21. The piezoelectric element 30 includes a piezoelectric body and driving electrodes. The driving electrodes are formed on respective principal surfaces of the piezoelectric element 30.

The piezoelectric element 30 is disposed on the principal surface 201 of the main plate 21. Here, the center of the piezoelectric element 30 coincides with the center of the main plate 21. Note that the term “coincide” above allows for the deviation between two centers within manufacturing tolerance.

The circumferential shape of the piezoelectric element 30 is smaller than the circumferential shape of the main plate 21. Accordingly, the main plate 21 has a region in which the piezoelectric element 30 is not present in the vicinity of the peripheral edge e21.

In this configuration, the thin portion 219 is formed by forming a recess 210 in the main plate 21. As illustrated in FIGS. 1, 2A, and 2B, the recess 210 is recessed into the main plate 21 from the principal surface 202. More specifically, the recess 210 is shaped annularly along the peripheral edge e21 of the main plate 21 with respect to the reference point (central point (rotation center)) positioned at the center o21 of the main plate 21. The depth of the recess 210 is smaller than the thickness of the main plate 21. The recess 210 is positioned so as to overlap the piezoelectric element 30 as viewed in plan. For example, the width of the recess 210 is approximately one fourth of the radius of the main plate 21 (in other words, one fourth of the distance between the center o21 and the peripheral edge e21). It is sufficient that the width be less than the radius.

Accordingly, as viewed in plan, the annularly shaped thin portion 219 is formed in the main plate 21 in a region that overlaps the piezoelectric element 30 and that does not include the center o21 and the peripheral edge e21.

The main plate 21 is made of a single material. Accordingly, the thin portion 219 is more vulnerable to deformation than the other part of the main plate 21. In other words, the thin portion 219 has an elastic modulus lower than that of the other part of the main plate 21. The thin portion 219 corresponds to a “low elastic modulus region” in the present disclosure.

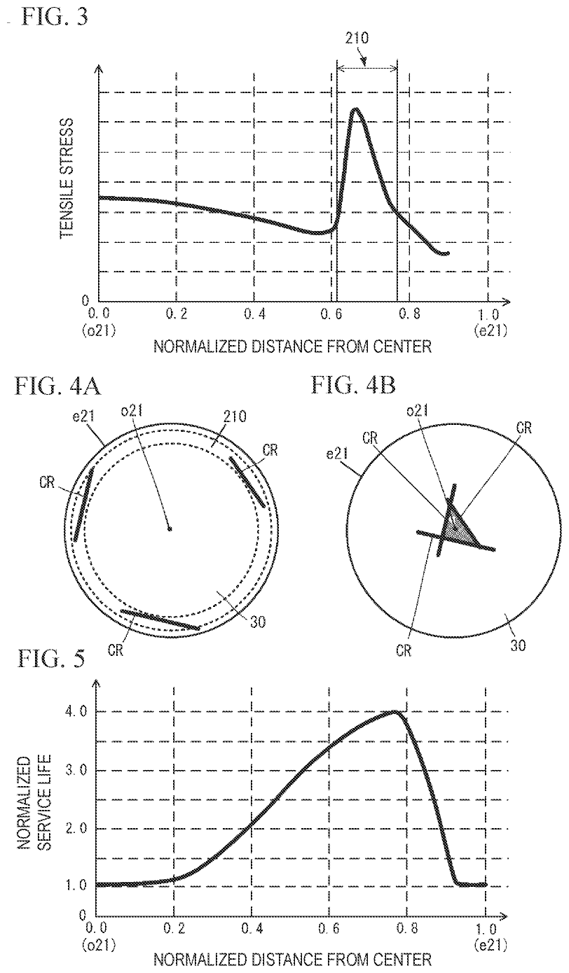

In this configuration, tensile stress is generated in the main plate 21 as described below. FIG. 3 is a graph illustrating an example distribution of tensile stress. In the graph of FIG. 3, the horizontal axis represents normalized distance from the center o21, and the vertical axis represents tensile stress acting in the piezoelectric element 30 when the main plate 21 vibrates in the bending vibration mode. The “normalized distance from the center o21” means the distance from the center o21 when the distance between the center o21 and the peripheral edge e21 is assumed to be one. FIG. 3 illustrates an example in which the thin portion 219 is formed at a position approximately between 0.6 and 0.8 in the normalized distance.

The thin portion 219 is formed at a position spaced from the center o21. As a result, a point at which a maximum amplitude of vibration occurs in the main plate 21 is shifted from the center o21 to a region where the thin portion 219 is present. Accordingly, as illustrated in FIG. 3, the piezoelectric element 30 is more vulnerable to the tensile stress in the vicinity of the thin portion 219. In other words, in the piezoelectric element 30, a maximum tensile stress occurs in the region near the thin portion 219 instead of the region near the center o21.

On the other hand, in a known actuator that does not have the thin portion 219 (of which the illustration is omitted), a maximum amplitude of vibration occurs at the center o21 of the main plate 21. Accordingly, in the known actuator, the tensile stress becomes greatest in the vicinity of the center o21.

Forming the thin portion 219, however, shifts the maximum tensile stress region from the center o21 to the thin portion 219, which reduces the tensile stress at the center o21 compared with the known actuator.

Occurrence of cracks CR in the piezoelectric element 30 caused by the tensile stress changes as illustrated in FIGS. 4A and 4B. FIG. 4A is a view illustrating an example of the generation of cracks CR in the actuator according to the first embodiment, and FIG. 4B is a view illustrating an example of the generation of cracks CR in the known actuator.

As illustrated in FIG. 4B, the tensile stress becomes greatest at the center o21 in the known actuator, and accordingly, cracks CR concentrate in the vicinity of the center o21. As a result, cracks CR tend to be connected to each other, which tends to result in the formation of an isolated region surrounded by the cracks CR. The formation of the isolated region reduces the amplitude of vibration of the actuator 11, which deteriorates the vibration characteristics of the actuator 11.

On the other hand, in the present embodiment as illustrated in FIG. 4A, cracks CR tend to occur in the piezoelectric element 30 in a region superposing the thin portion 219 because the tensile stress becomes greatest in the thin portion 219 positioned near the peripheral edge e21. Moreover, the cracks CR tend to occur so as to be spaced from each other. Accordingly, the cracks CR tend to be separated from each other. This reduces the occurrence of the isolated region surrounded by the cracks CR. A reduction in the occurrence of the isolated region suppresses a reduction in the amplitude of vibration of the actuator 11 and thereby suppresses the deterioration of the vibration characteristics.

According to the present embodiment, cracks CR occur in the piezoelectric element 30 in a discrete manner, which reduces the occurrence of the isolated region surrounded by the cracks CR. As a result, the actuator 11 can suppress a reduction in the amplitude of vibration and thereby suppress the deterioration of the vibration characteristics.

In the direction from the center o21 to the peripheral edge e21, the thin portion 219 of the main plate 21 is present at least in a region that overlaps the piezoelectric element 30 and that does not include the center o21 nor the peripheral edge e21. However, the reliability of the actuator 11 can be enhanced by positioning the thin portion 219 as described below.

FIG. 5 is a graph illustrating a relationship between the position of the thin portion 219 and normalized service life. In the graph of FIG. 5, the horizontal axis represents the normalized distance between the center o21 and the widthwise center of the thin portion 219. For example, the width of the thin portion 219 is approximately one fourth of the radius of the main plate 21. In the graph of FIG. 5, the vertical axis represents the duration between the time at which the actuator 11 starts to operate continuously and the time at which the characteristics of the actuator 11 deteriorate to a predetermined level when the duration for a known actuator having no thin portion 219 is assumed to be one.

As illustrated in FIG. 5, when the distance between the center o21 and the thin portion 219 is about 0.4 times or more and about 0.9 times or less of the distance between the center o21 and the peripheral edge e21, the service life of the actuator 11 can extend to approximately twice of that of the known actuator. Moreover, when the distance between the center o21 and the thin portion 219 is about 0.55 times or more and about 0.85 times or less of the distance between the center o21 and the peripheral edge e21, the service life of the actuator 11 can extend to approximately three times of that of the known actuator. Furthermore, when the distance between the center o21 and the thin portion 219 is about 0.8 times of the distance between the center o21 and the peripheral edge e21, the service life of the actuator 11 can extend to approximately four times of that of the known actuator.

In the actuator 11, the recess 210 is formed at the surface of the main plate 21 that is opposite to the surface on which the piezoelectric element 30 is disposed. Accordingly, the entire contact surface of the piezoelectric element 30 can come into contact with the main plate 21. In other words, the piezoelectric element 30 has no contact region that is not in contact with the main plate 21. This further reduces the occurrence of cracks CR caused by the tensile stress in the piezoelectric element 30.

In the actuator 11, the recess 210 and the thin portion 219 are disposed uniformly along the circumference of the main plate 21. This can suppress uneven vibrations occurring in different directions from the center o21 toward the peripheral edge e21, which improves the vibration characteristics of the actuator 11.

The width of the recess 210 does not need to be constant in the circumferential direction. The recess 210 may have a narrower portion and a wider portion. For example, narrower portions and wider portions may be formed alternately.

The depth of the recess 210 does not need to be constant in the circumferential direction. The recess 210 may have a shallower portion and a deeper portion. For example, shallower portions and deeper portions may be formed alternately.

The depth of the recess 210 does not need to be constant in the width direction. For example, in the width direction, the recess 210 is deeper at the center than at an edge.

### (Structure of Fluid Control Apparatus 10)

The fluid control apparatus 10 that includes the actuator 11 having the above-described structure can be formed as illustrated in FIG. 1. The fluid control apparatus 10 includes the actuator 11, a flat plate 40, and a side-wall member 50.

The flat plate 40 is disposed at the side of the principal surfaces 202 of the main plate 21, the frame 22, and the connection members 23 of the actuator 11. The flat plate 40 opposes the principal surface 202 of the main plate 21. The flat plate 40 corresponds to an “opposing plate” of the present disclosure. The flat plate 40 has multiple throughholes 400. The throughholes 400 are positioned so as to overlap the main plate 21 as viewed in plan.

The side-wall member 50 is shaped annularly and has an inside space 500. The side-wall member 50 is disposed between the flat plate member 20 of the actuator 11 and the flat plate 40. The inside space 500 has substantially the same shape as the opening defined by the inner peripheral edge of the side-wall member 50. The side-wall member 50 is connected to the frame 22 and also to the flat plate 40.

A space surrounded by the actuator 11, the side-wall member 50, and the flat plate 40 (in other words, the inside space 500 of the side-wall member 50) serves as a pump chamber. The pump chamber is in communication with an exterior space outside the fluid control apparatus 10 via the throughholes 400 of the flat plate 40. The pump chamber is also in communication with the exterior space outside the fluid control apparatus 10 via multiple openings 241 and 242 formed among the connection members 23 of the actuator 11.

In the fluid control apparatus 10 configured as above, the main plate 21 of the actuator 11 vibrates, and the fluid control apparatus 10 thereby draws a fluid in through the throughholes 400 and discharges the fluid through the openings 241 and 242. Alternatively, the fluid control apparatus 10 draws the fluid in through the openings 241 and 242 and discharges the fluid through the throughholes 400.

The fluid control apparatus 10 equipped with the actuator 11 configured as above can suppress the deterioration in the fluid transport efficiency. Thus, the reliability of the fluid control apparatus 10 can be improved.

### Second Embodiment

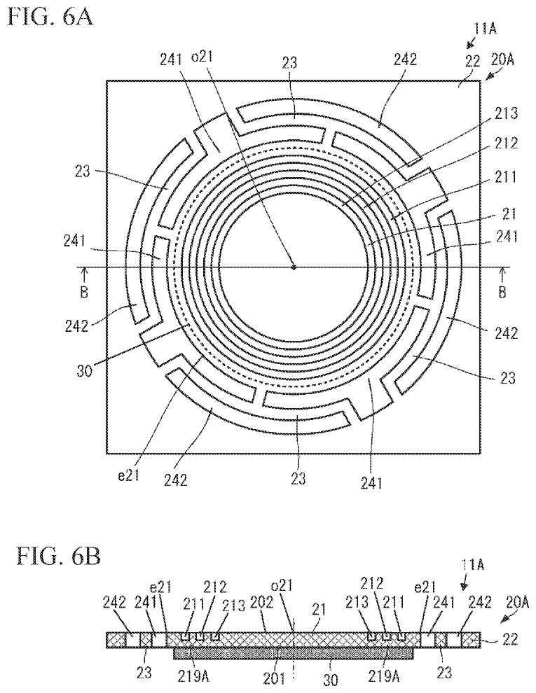

An actuator and a fluid control apparatus according to a second embodiment of the present disclosure will be described with reference to the drawings. FIG. 6A is a plan view illustrating the actuator according to the second embodiment, and FIG. 6B is a cross-sectional view thereof taken along line B-B in FIG. 6A.

As illustrated in FIGS. 6A and 6B, an actuator 11A of the second embodiment is different from the actuator 11 of the first embodiment in that a flat plate member 20A of the actuator 11A is configured differently. Other elements of the actuator 11A are similar to those of the actuator 11, and description of the similar elements will be omitted.

The flat plate member 20A includes a recess 211, a recess 212, and a recess 213 formed in the main plate 21. The recess 211, the recess 212, and the recess 213 are formed annularly so as to have different radii. More specifically, the radius of the recess 212 is smaller than that of the recess 211, and the radius of the recess 213 is smaller than that of the recess 212.

The recess 211, the recess 212, and the recess 213 are formed in this order in the direction from the center o21 toward the peripheral edge e21.

As a result, in the direction from the center o21 toward the peripheral edge e21, the average thickness of the main plate 21 in the region where the recesses 211 to 213 are formed is less than the thickness of the other part of the main plate 21. In other words, in the direction from the center o21 toward the peripheral edge e21, the region of the main plate 21 extending from the recess 211 to the recess 213 serves as a thin portion 219A.

The actuator 11A, which has multiple recesses 211, 212, and 213, can suppress a reduction in the amplitude of vibration even if cracks CR occur in the piezoelectric element 30, as is the case for the actuator 11.

With this configuration, even if the widths of the recesses 211 to 213 decrease, the thin portion can be formed so as to obtain similar effects as those for the recess 210. With this configuration, when the piezoelectric element 30 is fixed to the main plate 21, the piezoelectric element 30 can be pressed against the main plate 21 more entirely and uniformly. Accordingly, the piezoelectric element 30 can be fixed to the main plate 21 more reliably, which can further improve the reliability of the actuator 11A.

### Third Embodiment

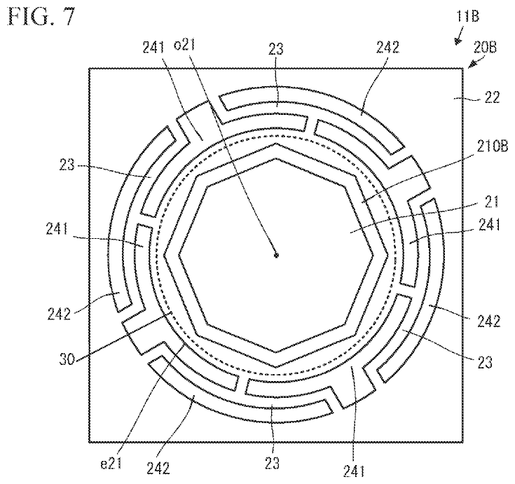

An actuator and a fluid control apparatus according to a third embodiment of the present disclosure will be described with reference to the drawings. FIG. 7 is a plan view illustrating the actuator of the third embodiment.

As illustrated in FIG. 7, an actuator 11B of the third embodiment is different from the actuator 11 of the first embodiment in that a flat plate member 20B of the actuator 11B is configured differently. Other elements of the actuator 11B are similar to those of the actuator 11, and description of the similar elements will be omitted.

The flat plate member 20B is different from the flat plate member 20 in that the main plate 21 of the flat plate member 20B has a recess 210B shaped octagonally and annularly as viewed in plan. In other words, the flat plate member 20B is different from the flat plate member 20 in that the main plate 21 has a thin portion shaped octagonally and annularly as viewed in plan. The recess 210B and the thin portion formed by the recess 210B are shaped annularly and octagonally with respect to the reference point (central point) positioned at the center o21 of the main plate 21.

The actuator 11B configured as above can suppress a reduction in the amplitude of vibration even if cracks CR occur in the piezoelectric element 30, as is the case for the actuator 11. In other words, the shape of the recess and of the thin portion is not limited to a circular shape but can be a regular polygon, which also can suppress a reduction in the amplitude of vibration even if cracks CR occur in the piezoelectric element 30 of the actuator 11B.

### Fourth Embodiment

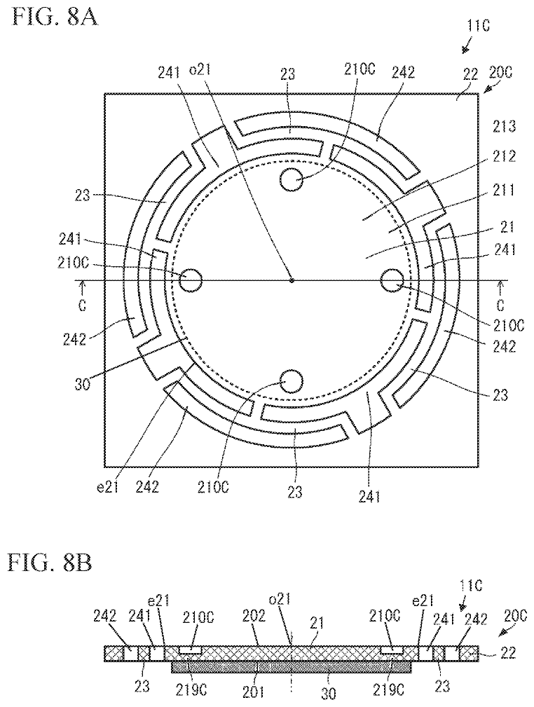

An actuator and a fluid control apparatus according to a fourth embodiment of the present disclosure will be described with reference to the drawings. FIG. 8A is a plan view illustrating the actuator according to the fourth embodiment, and FIG. 8B is a cross-sectional view thereof taken along line C-C in FIG. 8A.

As illustrated in FIGS. 8A and 8B, an actuator 11C of the fourth embodiment is different from the actuator 11 of the first embodiment in that a flat plate member 20C of the actuator 11C is configured differently. Other elements of the actuator 11C are similar to those of the actuator 11, and description of the similar elements will be omitted.

The flat plate member 20C is different from the flat plate member 20 in that the main plate 21 has multiple recesses 210C. The recesses 210C have circular shapes, respectively, as viewed in plan. The recesses 210C are disposed at predetermined intervals on a circle drawn with respect to the reference point (central point) positioned at the center o21 of the main plate 21. In the example illustrated in FIGS. 8A and 8B, the flat plate member 20C of the actuator 11C has four recesses 210C that are disposed at rotationally symmetrical positions with respect to the reference point (central point) positioned at the center o21 of the main plate 21. The angular difference between adjacent recesses 210C is 90 degrees.

With this configuration, the main plate 21 includes thin portions at positions where the recesses 210C are formed.

The actuator 11C configured as above can suppress a reduction in the amplitude of vibration even if cracks CR occur in the piezoelectric element 30, as is the case for the actuator 11. In other words, even if the recess and the thin portion are not shaped continuously and annularly, the recess and the thin portion can still suppress a reduction in the amplitude of vibration when cracks CR occur in the piezoelectric element 30 of the actuator 11C.

Note that the number and the arrangement of the recesses 210C are not limited to the example described above. In such a case, the spacing (or the angular difference) between adjacent recesses 210C can be adjusted in accordance with the number of the recesses 210C. More specifically, the spacing between adjacent recesses 210C can be obtained by dividing 360 degrees by the number of the recesses 210C. Accordingly, the recesses 210C are distributed evenly along the circumference of the main plate 21, which can suppress uneven vibrations occurring in different directions from the center o21 toward the peripheral edge e21 and thereby improve the vibration characteristics of the actuator 11C.

The shape of each recess 210C as viewed in plan is not limited to a circle. For example, each recesses 210C may be a polygon or, for example, like an arc elongated along the peripheral edge e21.

### Fifth Embodiment

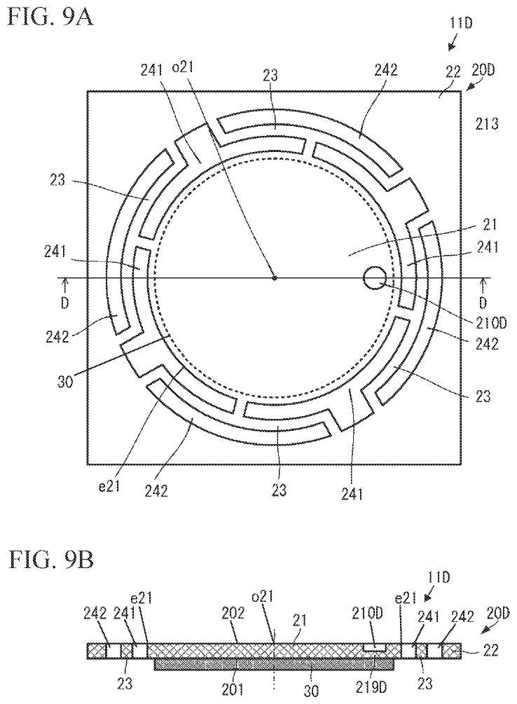

An actuator and a fluid control apparatus according to a fifth embodiment of the present disclosure will be described with reference to the drawings. FIG. 9A is a plan view illustrating the actuator according to the fifth embodiment, and FIG. 9B is a cross-sectional view thereof taken along line D-D in FIG. 9A.

As illustrated in FIGS. 9A and 9B, an actuator 11D of the fifth embodiment is different from the actuator 11C of the fourth embodiment in that a flat plate member 20D of the actuator 11D is configured differently. Other elements of the actuator 11D are similar to those of the actuator 11C, and description of the similar elements will be omitted.

The flat plate member 20D has a single recess 210D. With this configuration, the main plate 21 includes a thin portion at a position where the single recess 210D is formed.

The actuator 11D configured as above can suppress a reduction in the amplitude of vibration even if cracks CR occur in the piezoelectric element 30, as is the case for the actuator 11C. In other words, even if the recess and the thin portion are positioned only in a specific direction from the center o21, the recess and the thin portion can still suppress a reduction in the amplitude of vibration when cracks CR occur in the piezoelectric element 30 of the actuator 11D.

### Sixth Embodiment

An actuator and a fluid control apparatus according to a sixth embodiment of the present disclosure will be described with reference to the drawings. FIG. 10A is a plan view illustrating an actuator according to a sixth embodiment, and FIG. 10B is a cross-sectional view thereof taken along line E-E in FIG. 10A.

As illustrated in FIGS. 10A and 10B, an actuator 11E of the sixth embodiment is different from the actuator 11C of the fourth embodiment in that a flat plate member 20E of the actuator 11E is configured differently. Other elements of the actuator 11E are similar to those of the actuator 11C, and description of the similar elements will be omitted.

The flat plate member 20E is different from the flat plate member 20C in that the main plate 21 has multiple throughholes 210E formed therein. The throughholes 210E have circular shapes, respectively, as viewed in plan. The throughholes 210E are disposed at predetermined intervals on a circle drawn with respect to the reference point (central point) positioned at the center o21 of the main plate 21. In the example illustrated in FIGS. 10A and 10B, the flat plate member 20E of the actuator 11E has four throughholes 210E that are disposed at rotationally symmetrical positions with respect to the reference point (central point) positioned at the center o21 of the main plate 21. The angular difference between adjacent throughholes 210E is 90 degrees.

As a result, in the direction from the center o21 toward the peripheral edge e21, the average thickness of the main plate 21 in a region where the throughholes 210E are formed is less than the thickness of the other part of the main plate 21. Accordingly, in the direction from the center o21 toward the peripheral edge e21, a thin portion of the main plate 21 can be formed in the region where the throughholes 210E are formed.

The actuator 11E configured as above can suppress a reduction in the amplitude of vibration even if cracks CR occur in the piezoelectric element 30, as is the case for the actuator 11C.

Note that the number and the arrangement of the throughholes 210E are not limited to the above-described example. In such a case, the spacing (or the angular difference) between adjacent throughholes 210E can be adjusted in accordance with the number of the throughholes 210E. More specifically, the spacing between adjacent throughholes 210E can be obtained by dividing 360 degrees by the number of the throughholes 210E. Accordingly, the throughholes 210E are distributed evenly along the circumference of the main plate 21, which can suppress uneven vibrations in different directions from the center o21 toward the peripheral edge e21 and thereby improve the vibration characteristics of the actuator 11E.

### Seventh Embodiment

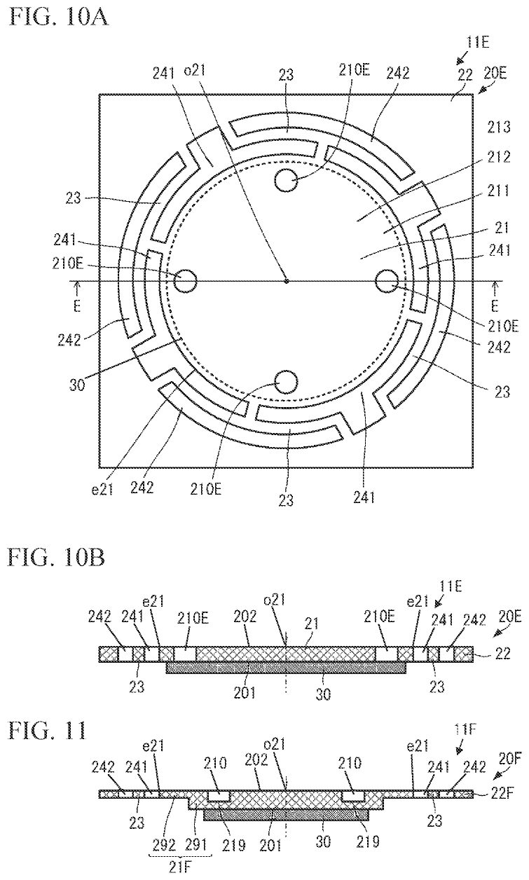

An actuator and a fluid control apparatus according to a seventh embodiment of the present disclosure will be described with reference to the drawings. FIG. 11 is a cross-sectional side view illustrating the actuator according to the seventh embodiment.

As illustrated in FIG. 11, an actuator 11F of the seventh embodiment is different from the actuator 11 of the first embodiment in that a flat plate member 20F of the actuator 11F is configured differently. Other elements of the actuator 11F are similar to those of the actuator 11, and description of the similar elements will be omitted.

The actuator 11F includes the flat plate member 20F. The flat plate member 20F includes a main plate 21F, a frame 22F, and connection members 23.

The main plate 21F includes a central portion 291 and a peripheral portion 292. The central portion 291 is thicker than the peripheral portion 292. The piezoelectric element 30 is disposed on the principal surface 201 of the central portion 291. The recess 210 is formed at the principal surface 202 of the central portion 291.

The actuator 11F configured as above can suppress a reduction in the amplitude of vibration even if cracks CR occur in the piezoelectric element 30, as is the case for the actuator 11.

In the actuator 11F, the thin peripheral portion 292 of the main plate 21F can increase the amplitude of vibration of the main plate 21F in the vicinity of the peripheral edge e21. Accordingly, the actuator 11F can further suppress a reduction in the amplitude of vibration.

### Eighth Embodiment

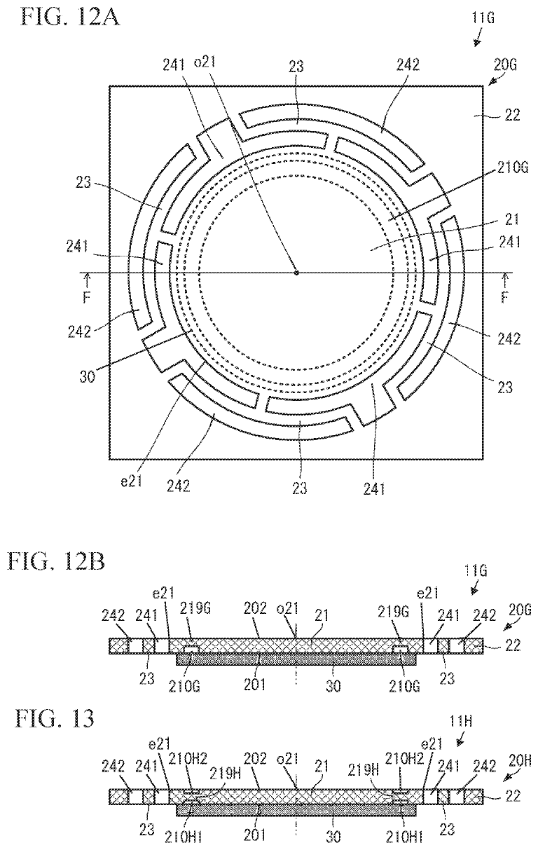

An actuator and a fluid control apparatus according to an eighth embodiment of the present disclosure will be described with reference to the drawings. FIG. 12A is a plan view illustrating the actuator of the eighth embodiment, and FIG. 12B is a cross-sectional view thereof taken along line F-F in FIG. 12A.

As illustrated in FIGS. 12A and 12B, an actuator 11G of the eighth embodiment is different from the actuator 11 of the first embodiment in that a flat plate member 20G of the actuator 11G is configured differently. Other elements of the actuator 11G are similar to those of the actuator 11, and description of the similar elements will be omitted.

The actuator 11G includes the flat plate member 20G. In the flat plate member 20G, the main plate 21 has a recess 210G formed at the principal surface 201. In other words, a thin portion 219G is formed at the principal surface 202 of the main plate 21.

The actuator 11G configured as above can suppress a reduction in the amplitude of vibration even if cracks CR occur in the piezoelectric element 30, as is the case for the actuator 11.

The surface of the main plate 21 facing the pump chamber can be made flat by applying this configuration of the actuator to the fluid control apparatus 10 described above. As a result, a pressure drop of the fluid in the pump chamber can be reduced.

### Ninth Embodiment

An actuator and a fluid control apparatus according to a ninth embodiment of the present disclosure will be described with reference to the drawings. FIG. 13 is a cross-sectional side view illustrating the actuator of the ninth embodiment.

As illustrated in FIG. 13, an actuator 11H of the ninth embodiment is different from the actuator 11 of the first embodiment in that a flat plate member 20H of the actuator 11H is configured differently. Other elements of the actuator 11H are similar to those of the actuator 11, and description of the similar elements will be omitted.

The actuator 11H includes the flat plate member 20H. In the flat plate member 20H, a recess 210H1 is formed at the principal surface 201 of the main plate 21, and a recess 210H2 is also formed at the principal surface 202 of the main plate 21. In other words, a thin portion 219H is formed at a middle position in the main plate 21 in the thickness direction thereof.

The actuator 11H configured as above can suppress a reduction in the amplitude of vibration even if cracks CR occur in the piezoelectric element 30, as is the case for the actuator 11.

Note that in the above description, the recess 210H1 and the recess 210H2 overlap each other entirely as viewed in plan. The recess 210H1 and the recess 210H2, however, may overlap each other partially or need not overlap each other as viewed in plan. The shapes of the recess 210H1 and the recess 210H2 may be identical or may be different. The recess 210H1 and the recess 210H2 can be formed by combining an annular recess with, for example, discrete circular recesses.

In the actuator 11H, the recess 210H1 and the recess 210H2 can be shaped in various different ways, which enables the thin portion 219H to have various different shapes.

In the above embodiments, the thin portion is formed by forming recesses or throughholes in the main plate by way of example. The above-described effects of the actuator, however, can be obtained by decreasing the elastic modulus of the region of the main plate that does not include the center o21 relative to the elastic modulus of the region that includes the center o21. Accordingly, the main plate can be made of a material having a low elastic modulus in the low elastic modulus region compared with the material of the main plate in the other region. A boundary may be formed between the low elastic modulus region and the high elastic modulus region.

The configurations of the above embodiments may be combined appropriately, and the combination may provide effects accordingly.
10 fluid control apparatus
11, 11A, 11B, 11C, 11D, 11E, 11F, 11G, 11H actuator
20, 20A, 20B, 20C, 20D, 20E, 20F, 20G, 20H flat plate member
21, 21F main plate
22, 22F frame
23 connection member
30 piezoelectric element
40 flat plate
50 side-wall member
201 principal surface
202 principal surface
210, 210B, 210C, 210D recess
210E throughhole
210G, 210H1, 210H2, 211, 212, 213 recess
219, 219A, 219G, 219H thin portion
241 opening
291 central portion
292 peripheral portion
400 throughhole
500 inside space

1. An actuator comprising:
a main plate having a first principal surface and a second principal surface, and having a rotationally symmetrical shape as viewed in plan in a direction normal to the first principal surface and the second principal surface;
a frame disposed at a position outside a peripheral edge of the main plate;
a connection member connected to the peripheral edge of the main plate and to the frame, the connection member holding the main plate so as to enable the main plate to vibrate relative to the frame; and
a piezoelectric element disposed on the first principal surface of the main plate, a circumferential shape of the piezoelectric element being smaller than the main plate as viewed in plan, wherein
the main plate includes a low elastic modulus region, as viewed in plan, overlapping the piezoelectric element and including neither the peripheral edge nor a rotation center of the main plate, and
the low elastic modulus region has an elastic modulus smaller than an elastic modulus of a central region of the main plate positioned in the vicinity of the rotation center.

2. The actuator according to claim 1, wherein
the low elastic modulus region comprises a thin portion in the main plate, the thin portion having a less plate thickness compared with the central region.

3. The actuator according to claim 2, wherein
the thin portion is provided with a recess being recessed from at least one of the first principal surface and the second principal surface.

4. The actuator according to claim 3, wherein
the recess is disposed at multiple positions arranged in rotational symmetry with respect to a reference point positioned at the rotation center.

5. The actuator according to claim 3, wherein
the recess has an annular shape with respect to a reference point positioned at the rotation center.

6. The actuator according to claim 3, wherein
the recess is provided at the second principal surface.

7. The actuator according to claim 3, wherein
the recess is disposed at multiple positions in a direction from the rotation center to the peripheral edge.

8. The actuator according to claim 1, wherein
the low elastic modulus region comprises at least one throughhole through the main plate between the first principal surface and the second principal surface, the throughhole being disposed in an annular region along the peripheral edge.

9. The actuator according to claim 8, wherein
the at least one throughhole comprises a plurality of throughholes disposed at multiple positions in the annular region, the multiple positions being spaced from each other.

10. A fluid control apparatus comprising:
the actuator according to claim 1;
an opposing plate opposing the second principal surface of the main plate, the connection member, and the frame and having a throughhole at a position opposing the main plate; and
a side-wall member connected to the opposing plate and to the frame in such a manner that the side-wall member, the main plate, the connection member, the frame, and the opposing plate form a pump chamber.

11. The actuator according to claim 4, wherein
the recess is provided at the second principal surface.

12. The actuator according to claim 5, wherein
the recess is provided at the second principal surface.

13. The actuator according to claim 4, wherein
the recess is disposed at multiple positions in a direction from the rotation center to the peripheral edge.

14. The actuator according to claim 5, wherein
the recess is disposed at multiple positions in a direction from the rotation center to the peripheral edge.

15. The actuator according to claim 6, wherein
the recess is disposed at multiple positions in a direction from the rotation center to the peripheral edge.

16. A fluid control apparatus comprising:
the actuator according to claim 2;
an opposing plate opposing the second principal surface of the main plate, the connection member, and the frame and having a throughhole at a position opposing the main plate; and
a side-wall member connected to the opposing plate and to the frame in such a manner that the side-wall member, the main plate, the connection member, the frame, and the opposing plate form a pump chamber.

17. A fluid control apparatus comprising:
the actuator according to claim 3;
an opposing plate opposing the second principal surface of the main plate, the connection member, and the frame and having a throughhole at a position opposing the main plate; and
a side-wall member connected to the opposing plate and to the frame in such a manner that the side-wall member, the main plate, the connection member, the frame, and the opposing plate form a pump chamber.

18. A fluid control apparatus comprising:
the actuator according to claim 4;
an opposing plate opposing the second principal surface of the main plate, the connection member, and the frame and having a throughhole at a position opposing the main plate; and
a side-wall member connected to the opposing plate and to the frame in such a manner that the side-wall member, the main plate, the connection member, the frame, and the opposing plate form a pump chamber.

19. A fluid control apparatus comprising:
the actuator according to claim 5;
an opposing plate opposing the second principal surface of the main plate, the connection member, and the frame and having a throughhole at a position opposing the main plate; and
a side-wall member connected to the opposing plate and to the frame in such a manner that the side-wall member, the main plate, the connection member, the frame, and the opposing plate form a pump chamber.

20. A fluid control apparatus comprising:
the actuator according to claim 6;
an opposing plate opposing the second principal surface of the main plate, the connection member, and the frame and having a throughhole at a position opposing the main plate; and
a side-wall member connected to the opposing plate and to the frame in such a manner that the side-wall member, the main plate, the connection member, the frame, and the opposing plate form a pump chamber.
